(19) United States
(12) Patent Application Publication
(10) Pub. No.: US 2026/0225920 A1
(43) Pub. Date: Aug. 6, 2026

(54) A PLATE HEAT EXCHANGER, A HEAT EXCHANGING PLATE AND A METHOD OF TREATING A FEED SUCH AS SEA WATER

(71) Applicant: ALFA LAVAL CORPORATE AB, Lund (SE)

(72) Inventor: Bo Juul Andersen, Snekkersten (DK)

(73) Assignee: ALFA LAVAL CORPORATE AB, Lund (SE)

(21) Appl. No.: 19/151,067

(22) PCT Filed: Jan. 30, 2024
(86) PCT No.: PCT/EP2024/052142

§ 371 Date: Jul. 25, 2025

(30) Foreign Application Priority Data
Feb. 7, 2023 (SE) 2350114-1

(51) Int. Cl. C02F 1/04; C02F 103/08; F28D 21/00; F28F 3/08

(52) U.S. Cl. CPC C02F 1/043; F28F 3/086; C02F 2103/08; C02F 2201/002; F28D 2021/0066; F28F 2215/06; F28F 2230/00

(57) ABSTRACT

The present invention relates to a plate for a plate heat exchanger for treatment of a feed. The plate defines a heating section for receiving and condensing a vaporized heating fluid. The heating section comprising a heating fluid inlet port for introducing the vaporized heating fluid into the heating section and a heating fluid outlet port for extracting a condensed heating fluid from the heating section. The plate further defines an evaporation section at least partially overlapping and defining a thermal interface with the heating section. The evaporation section comprising a feed inlet port for introducing the feed. The plate further defining a separation section and a condensation section comprising a feed outlet port for condensed feed.

The present invention relates to a method of treatment of a liquid feed such as sea water, a plate for a plate heat exchanger, a plate heat exchanger and a gasket for a plate heat exchanger.

### INTRODUCTION

Plate heat exchangers for distillation of a feed, such as desalination of seawater where evaporation, separation and condensation occur in the same plate package have been manufactured since many years. One example may be found in the international application WO 2006/104443 A1 assigned to the Alfa Laval Corporate AB. The disclosed heat exchanger has an evaporation section, a separation section and a condensation section. The evaporation section is arranged to permit evaporation of at least a part of the feed. The separation section is arranged to separate any non-evaporated liquid from the evaporated part of the feed. The condensation section is arranged to condense the evaporated part of the feed. The coondensed part of the feed forms the product, such as distilled water. A heating fluid is used for heat transfer to the feed flowing in evaporation section for providing the evaporation and a cooling medium is used for heat transfer to the evaporated part of the feed flowing in the condensation section for providing the condensation. The plate package may thus be closed by means of a gasket which extends around each plate. The advantage of the above-mentioned heat exchanger is that it does not need any container since the whole treatment of the seawater is performed in the plate package.

The above-mentioned technology is only using a single stage, i.e. a single treatment process volume in each plate package. However, multiple stages, i.e. multiple process volumes, in the same plate package are possible for improving the efficiency of the heat exchanger. This is known as a multi-stage heat exchanger or multi-effect heat exchanger. One example is found in WO 2019/234015 A1 in which each heat exchanging plate defines a first thermal interface between the heating volume and the evaporation section of a first process volume, a second thermal interface between the cooling volume and the condensation section of a second process volume, and at least one further thermal interface between an evaporation section and a condensation section of two adjacent process volumes. The heating fluid used for the above heat exchangers is typically a liquid such as jacket water from a ship engine or similar heated water from any other heat source. It can also be a gas such as steam and vapor.

CN 108622966 A describes a double effect five-in-one sea water desalting device. It discloses a heat source inlet channel being located above a heat source outlet channel. Both the heat source inlet channel and the heat source outlet channel being circular. The heat source flows into the heat source cavity from the heat source inlet channel, releases heat to the seawater in the first-effect evaporation area and then is discharged into the environment from the heat source outlet channel.

CN 202281539 UU discloses a falling film evaporator plate having multiple circular condensate outlet ports in its lower part.

CN 205279819 UU discloses a spiral heat exchanger having a lower steam inlet tube.

WO 2020/108985 A1 discloses a desalination plate having lower inlet for the heating fluid.

### SUMMARY OF THE INVENTION

Using a gaseous heating fluid such as steam can be advantageous as it is often readily available from the outlet of steam turbines and similar. The heating fluid is often discharged into the environment after it has transfered some of its heat to the evaporation section. It is therefore one object of the present invention to provide technologies for performing a distillation of a medium using a gaseous heating fluid. It is a further object to be able to produce a liquid product from the heating fluid after it has transfered some of its heat to the evaporation section.

The above object is achieved in a first aspect by a method of treatment of a liquid feed such as sea water, the method comprising:
providing a plate heat exchanger including a plate package comprising a plurality of heat exchanging plates, each heat exchanging plate comprising a first surface and an opposite second surface, the heat exchanging plates being arranged in a successive order with a gasket in-between and the heat exchanging plates are oriented such that first surfaces of adjacent plates are facing each other, and second surfaces of adjacent plates are facing each other, each heat exchanging plate further comprising:
   a heating section being located on the first surface,
   a heating fluid inlet port and a heating fluid outlet port in the heating section,
   an evaporation section being located on the second surface at least partially overlapping the heating section at an overlapping portion, the plate defining a thermal interface between the heating section and the evaporation section at the overlapping portion,
   a feed inlet port in the evaporation section,
   a separation section,
   a condensation section,
   a feed outlet port in the condensation section,
the method further comprising the steps of:
introducing a vaporized heating fluid into the heating section via the heating fluid inlet port,
introducing a liquid feed into the evaporation section via the feed inlet port,
   evaporating at least a part of the liquid feed in the evaporation section while condensing the vaporized heating fluid into a condensed heating fluid in the heating section,
   receiving the feed from the evaporation section into the separation section,
   separating the feed into a non-evaporated part of the feed and an evaporated part of the feed in the separation section,
   receiving the evaporated part of the feed from the separation section into the condensation section,
   condensing the evaporated part of the feed into a condensed feed in the condensation section,
discharging the condensed heating fluid from the heating section via the heating fluid outlet port, and
   discharging the condensed feed from the condensation section via the feed outlet port.

The present method is used for treatment of a liquid feed. The liquid feed is typically sea water and the treatment typically is in the form of desalination of sea water to achieve fresh water, however, other related applications are not excluded and some such relates applications will be discussed in the detailed description. The heat exchanging plate package comprises a plurality of heat exchanging plates of substantially equal size which are placed successively surface to surface, typically along a horizontal direction defining the depth of the plate package.

Each heat exchanging plate defines substantially the full height of the heat exchanger package between the opposite upper edge and lower edge and substantially the full width between the opposite side edges interconnecting the lower edge and the upper edge. The edges of the heat exchanging plates are mutually sealed by gaskets between the plates to establish parallel plate interspaces between the plates. Each heat exchanging plate define a first surface and a second surface being of different type and when assembled first surface to first surface and second surface to second surface two kinds of plate interspaces, i.e. first and second plate interspaces, are provided in alternating order, i.e. a first plate interspace is located adjacent two second plate interspaces and having gaskets in between, except of course the first and the last plate interspace along the horizontal direction.

The plates are typically bolted together in the plate package between opposite end plates. The plates are typically removable for maintenance. The heat exchanging plates are typically made of thermally conductive corrosion resistant materials such as stainless steel, aluminium or titanium.

The feed, which typically constitutes sea water, is introduced into the plate package via the feed inlet port to the evaporation section where at least a part of the feed is evaporated by heat transfer from the vaporized heating fluid on the opposite side of the heat exchanging plates. The separation section, which is located above the evaporation section, separates the evaporated part of the feed from the remaining part which essentially consisting of non-evaporated feed, typically brine. The separation section typically comprises rods, bars or corrugation etc. on which the non-evaporated feed gets trapped and is led out of the separation section. The condensation section allows the evaporated feed to condensate using a cooling fluid such as sea water on the opposite side of the heat exchanging plates. The condensed feed such as fresh water is collected at the heating fluid outlet port and led out of the heat exchanger package.

The vaporized heating fluid, such as steam, is introduced into the heating section via the heating fluid inlet port and performs a phase change from gas to liquid, i.e. a condensation, in the heating section. The condensed heating fluid is collected at the heating fluid outlet port. The condensation performed by the present method therefore allows a large amount of heat to transfer from the heating section to the evaporation section and at the same time the ability of generating a liquid product from the gaseous heating fluid.

The present plate heat exchanger essentially adds a condensing stage and can therefore act as a steam turbine condenser and produce liquid, e.g., water. It can therefore reduce costs significantly by avoiding large vessels, multiple piping's, pumps etc.

According to a further embodiment of the first aspect, the evaporation section and condensation section comprises obliquely extending ridges and valleys and the separation section comprises transversally extending ridges and valleys.

The evaporation section and condensation section comprise obliquely extending ridges and valleys arranged such that ridges of successive plates contact each other at contact points. In this way a good heat transfer may be achieved between the plate interspaces. The separation section comprises transversally extending ridges and valleys arranged such that ridges of successive plates fall into each other. In this way a good separation of droplets and vapor may be achieved.

According to a further embodiment of the first aspect, the plate comprising a non-evaporated feed outlet port in the separation section further comprising and the method comprising the step of discharging the non-evaporated part of the feed via the non-evaporated feed outlet port.

The non-evaporated part of the feed typically constitutes brine which should be removed from the plate package to provide space for new liquid feed. The non-evaporated feed outlet preferably being centrally located on the plate. A centrally located non-evaporated feed outlet may be beneficial for removing brine due to the roll on board a ship. Further, not having the non-evaporated feed outlet at the edge of the plate will allow more space on the plate for passage of evaporated feed.

According to a further embodiment of the first aspect, the separation section is located between the evaporation section and the condensation section.

The separation section should therefore preferably be located between the evaporation section and the condensation section for ensuring a proper separation between the evaporated feed and the non-evaporated feed.

According to a further embodiment of the first aspect, the evaporation section is located in the lower part of the plate when the heat exchanger is in use and the condensation section is located in the upper part of the plate when the heat exchanger is in use.

The evaporated feed rises upwards in the plate package since the evaporated feed has a lower density than the liquid feed. The condensation section should therefore preferably be located above the evaporation section.

According to a further embodiment of the first aspect the gasket being sloped towards the heating fluid outlet port, preferably the heating fluid outlet port is centrally located on the plate and more preferably two heating fluid inlet ports are provided at a respective side edge of the plate.

In this way the condensed heating fluid can flow towards the heating fluid outlet port by gravity. This improves the ability of collecting the condensed heating fluid. A gasket groove in the heat transfer plate being sloped towards the heating fluid outlet port can be used for accommodating the gasket. To allow the heat exchanger plate to be flipped 180 degrees about the central axis, the the heating fluid outlet port may be centrally located and two heating fluid inlet ports may be located on respective side of the heating fluid outlet port. The heating fluid inlet port should preferably be larger than the heating fluid outlet port.

According to a further embodiment of the first aspect, the condensation section is located on one of the first and second surfaces and the plate comprises a cooling section located on the opposite surface relative to the condensation section, the plate comprising a cooling fluid inlet port and a cooling fluid outlet port in the cooling section, the method further comprising the step of circulating a cooling fluid in the cooling section via the cooling fluid inlet port and the cooling fluid outlet port, the cooling fluid preferably being sea water and optionally the heated cooling fluid is used as feed.

The condensation section may be cooled by a cooling fluid such as sea water circulating in the cooling section opposite the condensation section. If using sea water in a desalination process, the outlet of the cooling section may be coupled to the feed inlet to get a preheating of the feed.

According to a further embodiment of the first aspect, each plate further comprising:
a secondary evaporation section on the opposite surface of the plate relative to the condensation section, the secondary evaporation section at least partly overlapping the condensation section at a secondary overlapping portion on the opposite surface of the plate relative to the condensation section, the plate defining a thermal interface between the condensation section and the secondary evaporation section at the secondary overlapping portion,
a secondary feed inlet port in the secondary evaporation section,
a secondary separation section,
a secondary condensation section, and
a secondary feed outlet port in the secondary condensation section, the method further comprising the steps of:
introducing the secondary feed via the secondary feed inlet,
evaporating at least a part of a secondary feed in the secondary evaporation section,
receiving the secondary feed from the secondary evaporation section into the secondary separation section,
separating the secondary feed into a non-evaporated part of the secondary feed and an evaporated part of the secondary feed,
receiving the evaporated part of the secondary feed from the secondary separation section into the secondary condensation section,
condensing the evaporated part of the secondary feed into a condensed secondary feed in the secondary condensation section, and
discharging the condensed secondary feed at the secondary feed outlet.

The pressure in the process volumes may be adjusted to allow the feed to evaporate in the evaporation sections and to condensate in the condensation sections at suitable temperatures.

According to a further embodiment of the first aspect, the secondary condensation section is located on one of the first and second surfaces and the plate comprises a cooling section located on the opposite surface relative to the secondary condensation section, the plate comprising a cooling fluid inlet port and a cooling fluid outlet port in the cooling section, the method further comprising the step of circulating a cooling fluid in the cooling section via the cooling fluid inlet port and the cooling fluid outlet port, the cooling fluid preferably being sea water and optionally the heated cooling fluid is used as feed.

The condensation section may be cooled by a cooling fluid such as sea water circulating in the cooling section opposite the condensation section. If using sea water in a desalination process, the outlet of the cooling section may be coupled to the feed inlet to get a preheating of the feed.

According to a further embodiment of the first aspect, the method comprising:
providing a further heat exchanger including a further plate package comprising a plurality of further heat exchanging plates, each further heat exchanging plate comprising a further first surface and an opposite further second surface, each further heat exchanging plate further comprising:
a tertiary evaporation section,
a tertiary feed inlet port in the tertiary evaporation section,
a tertiary separation section,
a tertiary condensation section,
a tertiary feed outlet port in the tertiary condensation section, the method further comprising the steps of:
introducing the tertiary liquid feed into the tertiary evaporation section via the tertiary feed inlet port,
   evaporating at least a part of the tertiary liquid feed in the tertiary evaporation section,
   receiving the tertiary feed from the evaporation section into the separation section,
   separating the tertiary feed into a non-evaporated part of the tertiary feed and an evaporated part of the tertiary feed,
   receiving a first part of the evaporated part of the tertiary feed from the tertiary separation section into the tertiary condensation section,
   condensing the first part of the evaporated part of the tertiary feed into a condensed tertiary feed in the tertiary condensation section,
discharging the condensed tertiary feed from the tertiary condensation section via the tertiary feed outlet port, and
flowing a second part of the evaporated part of the tertiary feed into the heating fluid inlet port as vaporized heating fluid.

In the present embodiment a further plate heat exchanger is provided. The further plate heat exchanger is substantially identical to the plate heat exchanger defined in the previous embodiments simply as the “plate heat exchanger”. The vaporized heating fluid for the further plate heat exchanger is taken from the first plate heat exchanger. This is done by flowing the remaining part of the evaporated part of the tertiary feed, i.e the part which is not received in the tertiary condensation section, into the heating fluid inlet port of the plate heat exchanger, i.e, the “first” heat exchanger. In this way the remaining part of the evaporated part of the tertiary feed is replacing the vaporized heating fluid in the first plate heat exchanger. The condensed heating fluid from the first plate heat exchanger is then condensed feed and may be treated accordingly. In this way multiple stages are realized using different plate packages and energy may be conserved.

According to a further embodiment of the first aspect, the further heat exchanging plate comprising:
a further heating section being located on the further first surface while the tertiary evaporation section being located on the further second surface, the further heating section at least partially overlapping the tertiary evaporation section at an overlapping portion, the further plate defining a thermal interface between the further heating section and the tertiary evaporation section at the overlapping portion
a tertiary heating fluid inlet port and a tertiary heating fluid outlet port at the further heating section,
the method further comprising the steps of:
introducing a further vaporized heating fluid into the further heating section via the tertiary heating fluid inlet port,
condensing the further vaporized heating fluid in the further heating section into a condensed heating fluid, and
discharging the condensed heating fluid from the further heating section via the tertiary heating fluid outlet port.

The further heat exchanger may be using vaporized heating fluid.

According to a further embodiment of the first aspect, the further heat exchanging plate comprising:
a further heating section being located on the further first surface while the tertiary evaporation section being located on the further second surface, the further heating section at least partially overlapping the tertiary evaporation section at an overlapping portion, the further plate defining a thermal interface between the further heating section and the tertiary evaporation section at the overlapping portion,
a tertiary heating fluid inlet port and a tertiary heating fluid outlet port at the further heating section,
the method further comprising the steps of:
introducing a liquid heating fluid into the further heating section via the tertiary heating fluid inlet port, and
discharging the liquid heating fluid from the further heating section via the tertiary heating fluid outlet port.

Alternatively, the further heat exchanger may be using liquid heating fluid.

According to a further embodiment of the first aspect, the heating fluid outlet port is located below the evaporation section when the heat exchanger is in use.

The condensed heating fluid outlet port can be located below the evaporation section to be able to better collect the condensate.

The above object is achieved in a second aspect by plate for a plate heat exchanger for treatment of a feed such as sea water, the plate heat exchanger including a plate package comprising a plurality of heat exchanging plates, the heat exchanging plate comprising a first surface and an opposite second surface, the heat exchanging plate further comprising:
a heating section being located on the first surface,
a heating fluid inlet port in the heating section for introducing a vaporized heating fluid into the heating section and a heating fluid outlet port in the heating section for discharging a condensed heating fluid in the heating section,
an evaporation section being located on the second surface at least partially overlapping the heating section at an overlapping portion, the plate defining a thermal interface between the heating section and the evaporation section at the overlapping portion for evaporating at least a part of a liquid feed in the evaporation section while condensing the vaporized heating fluid into the condensed heating fluid in the heating section,
a feed inlet port in the evaporation section for introducing the liquid feed into the evaporation section,
a separation section for separating the feed into a non-evaporated part of the feed and an evaporated part of the feed in the separation section,
a condensation section for condensing the evaporated part of the feed into a condensed feed,
a feed outlet port in the condensation section for discharging the condensed feed from the condensation section.

The above object is achieved in a third aspect by plate heat exchanger for treatment of a feed such as sea water, the plate heat exchanger including a plate package comprising a plurality of heat exchanging plates, the plates being arranged in a successive order with a gasket in-between and the plates are oriented such that first surfaces of adjacent plates are facing each other and second surfaces of adjacent plates are facing each other.

The above object is achieved in a fourth aspect by gasket for a plate heat exchanger, the gasket comprising an upper gasket member, a lower gasket member opposite the upper gasket member and two parallel side gasket members interconnecting the lower gasket member and the upper gasket member.

### BRIEF DESCRIPTION OF THE DRAWINGS

FIG. 1 is a side view of a plate heat exchanger of the present invention.

FIG. 2 is a perspective view of the plate package of the present invention.

FIG. 3A is the first surface of a first embodiment of the present invention.

FIG. 3B is the second surface of a first embodiment of the present invention.

FIG. 4A is the first surface of a second embodiment of the present invention.

FIG. 4B is the second surface of a second embodiment of the present invention.

FIG. 5 is a cross-section view of the plate package of the present invention.

FIG. 6A is the first surface of a third embodiment of the present invention.

FIG. 6B is the second surface of a third embodiment of the present invention.

FIG. 7 is a single steam-driven heat exchanger of the present invention.

FIG. 8 is a double steam-driven heat exchanger setup of the present invention.

FIG. 9 is a hot water driven heat exchanger setup of the present invention.

### DETAILED DESCRIPTION OF THE DRAWINGS

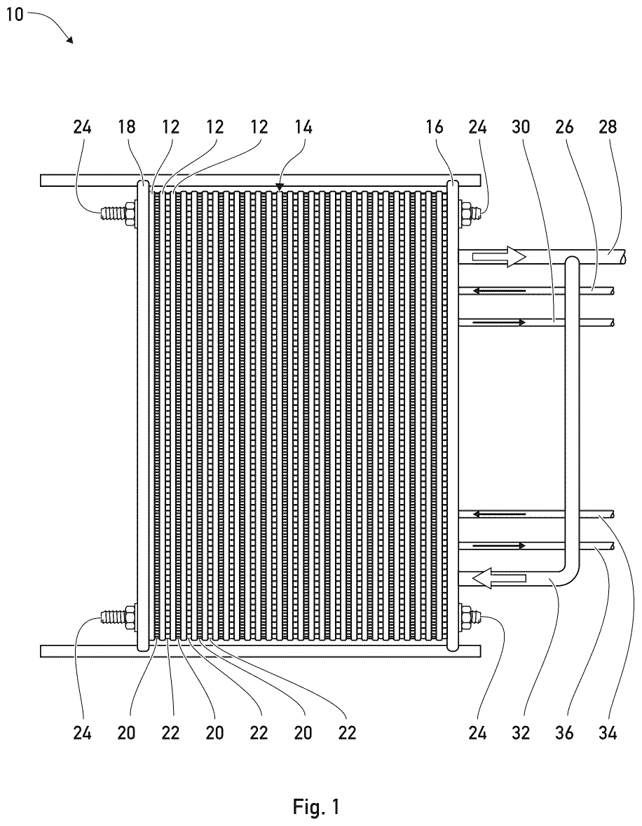

FIG. 1 shows a side view of a plate heat exchanger. In the following description an application with respect to desalination of seawater is described, i.e., the liquid feed is sea water. However, it is to be noted that the present plate heat exchanger can also be used for treatment of other feeds, for instance distillation of other liquids than water or producing concentrated liquids, such as fruit juice concentrate from a raw fruit juice etc. The plate heat exchanger 10 comprises a large number of compression moulded heat exchanger plates 12, which are provided in parallel to each other and successively face to face in such a way that they form a plate package 14. At the respective ends, the plate package 14 is provided between a frame plate 16 and a pressure plate 18.

Between the heat exchanger plates 12, first plate interspaces 20 and second plate interspaces 22 are formed. First plate interspaces 20 and second plate interspaces 22 are provided between opposing first surfaces and second surfaces, respectively, in an alternating order in the plate package 14 in such a way that substantially each first plate interspace 20 is surrounded by two second plate interspaces 22, and substantially each second plate interspace 22 is surrounded by two first plate interspaces 20. Different sections in the plate package 14 are delimited from each other by means of gaskets (not shown) in each plate interspace whereby the first plate interspace 20 includes a first type gasket (not shown) and the second plate interspace 22 includes a second type gasket (not shown). The plate package 14, i.e., the heat exchanger plates 12 and the gaskets (not shown) provided therebetween, is kept together by means of schematically indicated tightening bolts 24 in a manner known per se.

The plate package 14 is connected to a cooling water inlet conduit 26, a cooling water outlet conduit 28 and a freshwater outlet conduit 30. The cooling water is typically sea water and thus the cooling water outlet conduit 28 is connected to a sea water inlet conduit 32 for recovering the heat absorbed by the cooling water. The plate package 12 is further connected to a vaporized heating fluid inlet conduit 34 and a condensed heating fluid outlet conduit 36. The heating fluid is used for evaporating the feed, i.e. the sea water which is entering the plate package 14 through the sea water inlet conduit 32 and at the same time the vaporized heating fluid is condensed. The vaporized heating fluid may be steam, such as steam originating from a steam turbine. The condensed fresh water is leaving the plate package 14 through the freshwater outlet conduit 30. The condensed heating fluid is leaving the plate package 14 through the heating fluid outlet conduit 36.

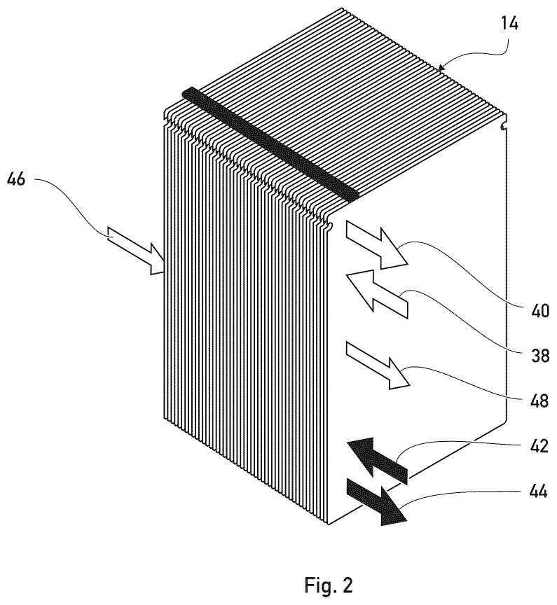

FIG. 2 shows a perspective view of the plate package 14. Here, the ports have been schematically illustrated by arrows and define: Cooling fluid inlet port 38, cooling fluid outlet port 40, vaporized heating fluid inlet port 42, condensed heating fluid outlet port 44, untreated feed inlet port 46 and treated feed outlet port 48.

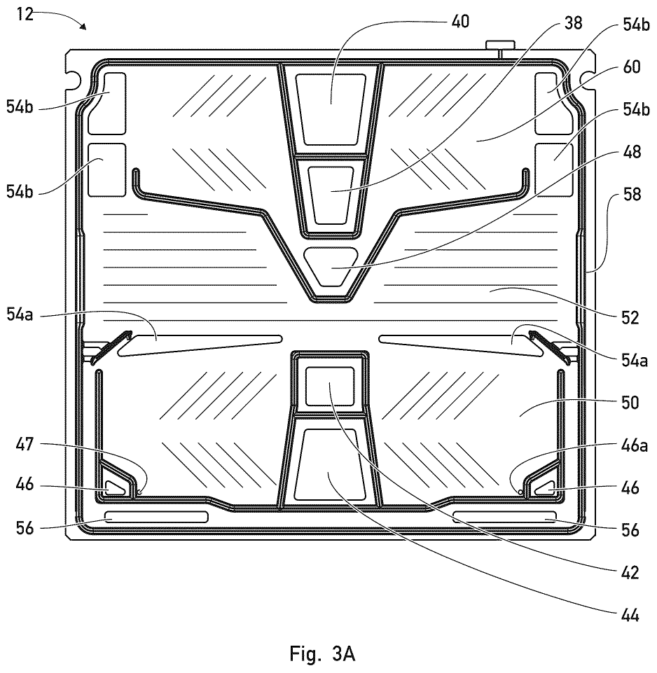

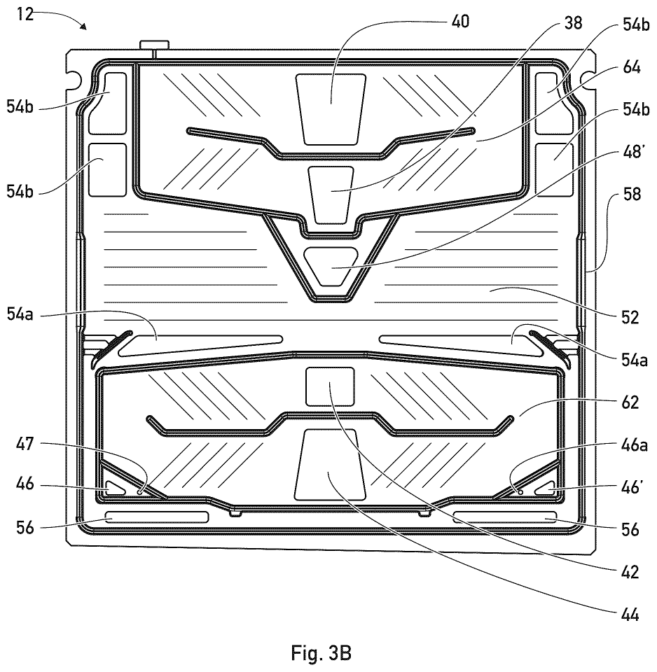

FIG. 3A shows the first surface of a first embodiment of one of the plates 12 of the plate package as defined above. The present plate 12 can be used for both vaporized heating fluid, e.g. steam, and liquid heating fluid, e. g jacket water, however, in the following it is assumed that vaporized heating fluid is used. The cooling fluid inlet port 38, the cooling fluid outlet port 40, the vaporized heating fluid inlet port 42 and the condensed heating fluid outlet port 44 are sealed off the present side of the plate 12, defining a first plate interspace. The liquid feed from the untreated feed inlet port 46 enters the evaporation section 50 via a feed inlet hole 47. The liquid feed is evaporated in the evaporation section 50 and the evaporated feed flows to the separation section 52 located above the evaporation section 50. The evaporated feed also flows through the plate 12 via passages 54a 54b in the plate 12 to the neighbouring plate interspaces. The passages 54a 54b ensures that the evaporated feed reaches both sides of the plate 12 at the separation section 50. Non-evaporated feed flows out via the non-evaporated feed outlet port 56. The non-evaporated feed constitutes brine in a desalination plant but may alternatively constitute a product concentrate such as juice concentrate. The gasket 58 is represented by the thick black line. The (pure) evaporated feed excluding the non-evaporated feed then flows to the condensation section 60 located above the separation section 52. In the condensation section 60 the pure evaporated feed is condensed and led out via the treaded feed outlet port 48.

FIG. 3B shows the second surface, opposite the first surface described above in connection with FIG. 3A, of the above-mentioned plate 12. Vaporized heating fluid is introduced into the heating section 62 via the vaporized heating fluid inlet port 42 and flows towards the condensed heating fluid outlet port 44 across an area of the heating section 62 located opposite to and in thermal contact with the evaporation section on the opposite side of the plate 12. The vaporized heating fluid transfers heat to the liquid feed on the opposite side of the plate 12 and the vaporized heating fluid is thereby condensed into a liquid product. The liquid product is collected at the condensed heating fluid outlet port 44 which is located in the heating section 62 but below the vaporized heating fluid inlet port 42. The cooling fluid is introduced into the cooling section 64 via the cooling fluid inlet port 38 and flows towards the cooling fluid outlet port 40 for cooling the opposite condensation section.

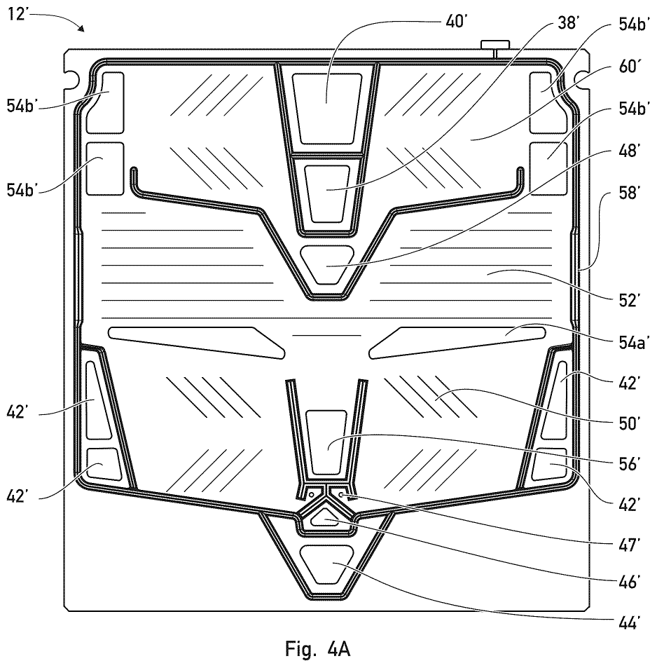

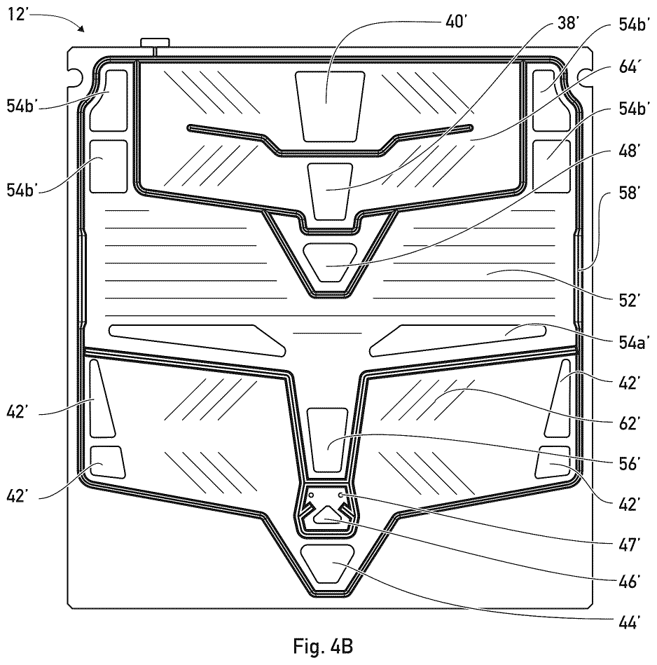

FIG. 4A shows the first surface of an alternative embodiment of the plate 12′ of an alternative plate package. The present plate 12′ is optimised to be used for vaporized heating fluid, e.g. steam. The cooling fluid inlet port 38′, the cooling fluid outlet port 40′, the vaporized heating fluid inlet ports 42′ and the condensed heating fluid outlet port 44′ are sealed off the present side of the plate 12′, defining a first plate interspace. The liquid feed from the untreated feed inlet port 46′ enters the evaporation section 50′ via the feed inlet hole 47′. The liquid feed is evaporated in the evaporation section 50′ and the evaporated feed flows to the separation section 52′ located above the evaporation section 50′ and through the plate 12′ via passages 54a′ 54b′ to the neighbouring plate interspaces. The passages 54a′ 54b′ ensures that the evaporated feed reaches both sides of the plate 12′ in the separation section. Non-evaporated feed flows out via the central non-evaporated feed outlet port 56′. The non-evaporated feed constitutes brine in a desalination plant but may alternatively constitute a product concentrate such as juice concentrate. The gasket 58′ is represented by the thick black line. The pure evaporated feed then flows to the condensation section 60′ located above the separation section 52′. In the condensation section 60′, the pure evaporated feed is condensed and led out via the treaded feed outlet port 48′.

FIG. 4B shows the second surface, opposite the first surface described above in connection with FIG. 4A, of the above-mentioned plate 12′. Vaporized heating fluid is introduced into the heating section 62′ via the vaporized heating fluid inlet ports 42′ and flows towards the condensed heating fluid outlet port 44′. The heating fluid flows across an area of the heating section 62′ located opposite to and in thermal contact with the evaporation section on the opposite side of the plate 12′. The vaporized heating fluid transfers heat to the liquid feed on the opposite side of the plate 12 and the vaporized heating fluid is thereby condensed into a liquid product. The liquid product is collected at the condensed heating fluid outlet port 44′ which is located in the heating section 62′ but below the vaporized heating fluid inlet port 42′. The cooling fluid is introduced into the cooling volume 64′ via the cooling fluid inlet port 38′ and flows towards the cooling fluid outlet port 40′ for cooling the opposite condensation section.

The present embodiment has an improved ability of collecting the condensed heating fluid due to the sloping lower gasket of the heating section 62′. Further, the condensed heating fluid outlet port 44′ is located below the evaporation section thus being able to better collect the condensate.

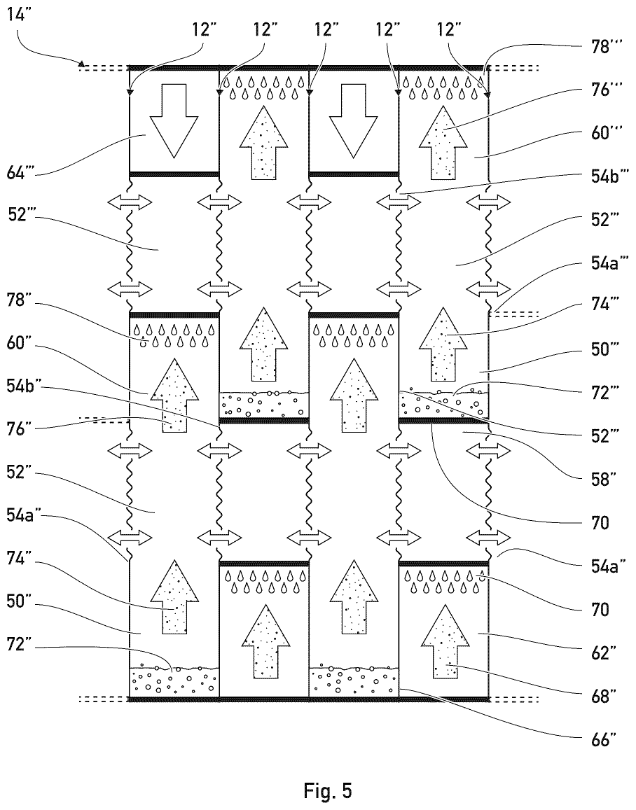

FIG. 5 shows a cross section view of the plate package 14″. Vaporized heating fluid 68″ is introduced into the heating volume 62″. The plates 12″ form thermal interfaces 66″ between the heating volume 62″ and an adjacent first evaporation section 50″. The first part of liquid feed 72″ is introduced into the lower part of the first evaporation section 50″. The first part of liquid feed 72″ is heated by the vaporized heating fluid 68″ in the heating volume 62″ through the thermal interface such that the first part of liquid feed 72″ is evaporated forming a first part of evaporated feed 74″, typically being steam in case of an aqueous feed in e.g. a desalination plant. At the same time the vaporized heating fluid 68″ is condensed into a condensed heating fluid 70″ forming a liquid product. The first part of vaporised feed 74″ is moving upwards as shown by the arrows and enters a first separation section 52″. In the first separation section 52″, any non-evaporated feed is removed from the first part of evaporated feed 74″ to form a first part of pure evaporated feed 76″. Passages 54a″ 54b″ are formed through the plates 12″ in the separation section 52″ to allow the first part of evaporated feed 74″ and the first part of pure evaporated feed 76″ to flow on both side of the plate 12″. The first part of pure vaporised feed 76″ then enters a first condensation section 60″. In the first condensation section 60″, the first part of pure vaporised feed 76″ is condensed into a first part of condensate 78″, which constitutes fresh water in the present application.

At the first condensation section 60″ the plates 12″ form a thermal interface with a second evaporation section 50′″. A second part of liquid feed 72′″ is introduced into the lower part of the second evaporation section 50′″. In the second evaporation section 50′″ the pressure and temperature is lower than in the first evaporation section 50″. The second part of liquid feed 72′″ in the second evaporation section 50′″ will thus evaporate at a lower temperature than the liquid feed 72″ in the first evaporation section 50″. The second part of the liquid feed 72′″ is heated by the pure evaporated feed 76″ in the first condensation section 60″ through the thermal interface of the plate 12″ such that the second part of the liquid feed 72′″ is evaporated to form a second part of evaporated feed 74′″ and the first part of pure evaporated feed 76″ in the first condensation section 60″ is condensed into the first part of condensate 78″.

The second part of evaporated feed 74′″ in the second evaporation section 50′″ is moving upwards as shown by the arrows and enters a second separation section 52′″. In the second separation section 52′″, any non-evaporated feed is removed. Passages 54a′″ 54b′″ are formed in the plate 12″ in the second separation section 52′″. The second part of pure evaporated feed 76′″ then enters a second condensation section 60′″. In the second condensation section 60′″, the second part of pure evaporated feed 76′″ is condensed into a second part of condensate 78′″, which typically constitutes fresh water.

A cooling volume 64′″ is provided at the top of the plate package 14″. In the cooling volume 64′″, a cooling medium such as sea water is circulated. The cooling medium cools the second condensation section 60′″ via a thermal interface in the plates 12′″. Thereby the pure evaporated feed 76′″ is condensed into the second part of condensate 78′″.

The non-evaporated feed constitutes a brine having an elevated salinity and which is led out of the plate package 14″. In other applications, the non-evaporated feed may be the product, e.g., in case of a plant for producing juice concentrate, the feed is raw fruit juice and the non-evaporated feed constitutes the juice concentrate. Similar processes may be used for non-aqueous feeds such as refinement of ethanol etc

The thick black lines 58″ form gaskets which encloses the plate interspaces and separates volumes inside the plate package 14″. The ports and passages interconnect the plate interspaces.

The present plate package 14″ operates in two stages having two separate evaporation sections 50″ 50′″ on the same plate 12″ where the liquid feed 72″ 72′″ is evaporated and two respective condensation sections 60″ 60′″ on the same plate 12′ where the evaporated feed 76″ 76′″ is condensed. However, in addition to the two condensation sections 60″ 60′″ where the evaporated feed 76″ 76′″ is condensed there is also condensation of the vaporized heating fluid 68″ in the heating section 62″ and thus there are three separate areas of condensation on the same plate 12″. Each heat exchanging plate 12″ has condensation in a heating section 62″, a thermal interface 66″ between the heating section 62″ and a first evaporation section 50″ in which a first part of the liquid feed 72″ is evaporated, a second thermal interface between a first condensation section 60″ at which a first part of the pure evaporated feed 76″ is condensed and a second evaporation section 50′″ in which a second part of the liquid feed 72′″ is evaporated and a third thermal interface between a second condensation section 60′″ in which a second part of the pure evaporarted feed 76′″ is condensed and a cooling section 64′″ in which a cooling fluid is circulated. The cooling fluid should be significantly cooler than the heating fluid.

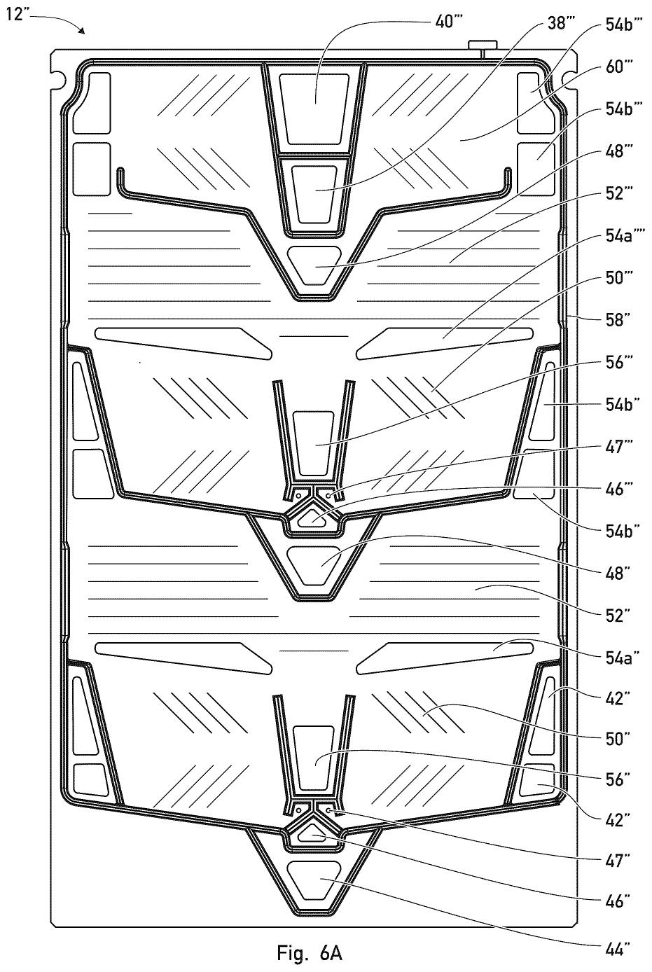

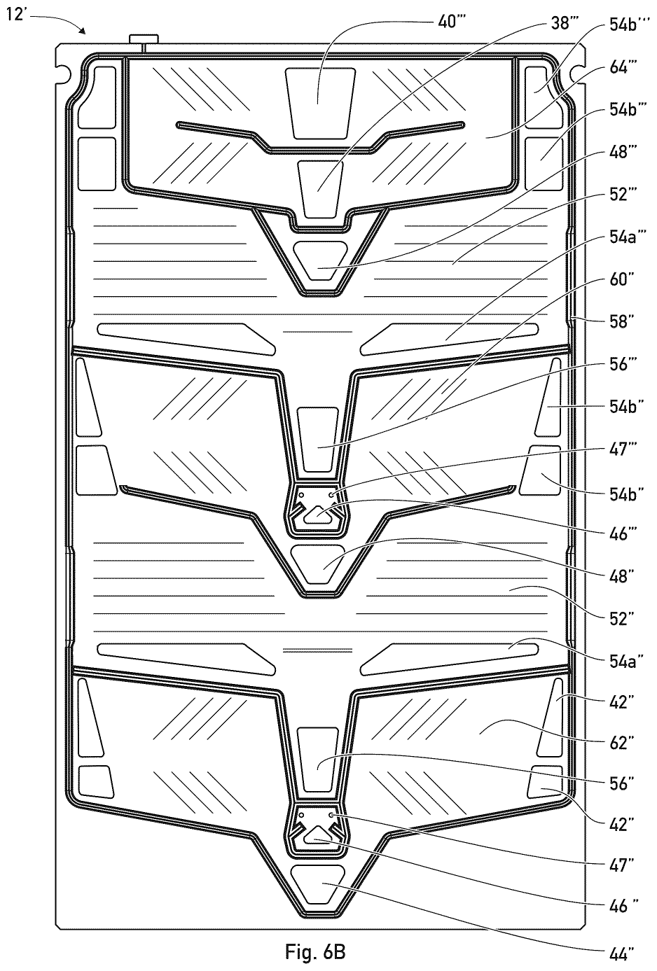

FIG. 6A shows the first surface of one of the plates 12″ of the plate package 14″ defining a first plate interspace. The cooling fluid inlet port 38′″ and cooling fluid outlet port 40′″, the vaporized heating fluid inlet port 42″, the condensed feed outlet port 48″ and the condensed heating fluid outlet port 44″ are sealed off the present side of the plate 12″, and respective port being in communication with the opposite side of the plate 12″. The liquid feed from the untreated feed inlet port 46″ enters the first evaporation section 50″ via a feed inlet hole 47″. The evaporated feed from the evaporation section 50″ flows to the first separation section 52″ located above the first evaporation section 50″ and through the plate 12″ via passages 54a″ 54b″ to the neighbouring plate interspaces. The passages 54a″ 54b″ ensures that the evaporated feed reaches both sides of the plate 12″ at the separation section. Non-evaporated feed flows out via the non-evaporated feed outlet port 56″. The non-evaporated feed constitutes brine in a desalination plant but may alternatively constitute a product concentrate such as juice concentrate. The first condensation section of the first process volume is located on the opposite side of the plate and is thus not shown in the present view (described in relation to FIG. 6B).

Evaporation is also taking place in the second evaporation section 50″ using heat from an opposite first condensation section (described in relation to FIG. 6B). The liquid feed is introduced into the second evaporation section 50′″ via untreated feed inlet port 46′″ and feed inlet hole 47′″. The evaporated feed flows through the second separation section 52′″ to a second condensation section 60′″ where the evaporated feed condenses into liquid. The condensate leaves the condensation section 60′″ via the treated feed outlet port 48′″.

The untreated feed inlet ports 46″ 46′″ for introducing feed are centrally located on the plate 12. It allows for a better utilisation of the plate area compared to having the feed inlet ports at the edge of the plate. This allows more space for the evaporation.

Further, the non-evaporated feed outlet ports 56″ 56′″ are also centrally located on the plate 12″. A centrally located non-evaporated feed outlet may be beneficial due to the roll on board a ship.

The gasket 58″ is represented by the thick black line.

FIG. 6B shows the second surface, opposite the first surface described above in connection with FIG. 6A, of the above-mentioned plate 12″. Vaporized heating fluid is introduced into the heating section 62″ via the heating fluid inlet ports 42″ The heating section 62″ is opposite to and in thermal contact with the first evaporation section on the opposite side of the plate 12″. The vaporized heating fluid transfers heat to the liquid feed on the opposite side of the plate 12″ and is thereby condensed into a liquid product. The liquid product is collected at the condensed heating fluid outlet port 44″ which is located in the heating section 62″ but below the first evaporation section on the opposite side of the plate 12″.

The cooling fluid is circulating in the cooling volume 64″ between the cooling fluid inlet port 38′″ and the cooling fluid outlet port 40′″ for cooling the opposite second condensation section. The first condensation section 60″ is heating the second evaporation section located on the opposite side of the plate 12″. Evaporated feed passes through the passages 54a″ 54b″ 54a′″ 54b′″ in the respective separation sections 52″ 52′″ for utilizing both sides of the plate 12″ for separation of evaporated feed and non-evaporated feed. The condensed feed leaves the condensation section 60″ via the treated feed outlet port 48″. The gasket 58″ is represented by the thick black line.

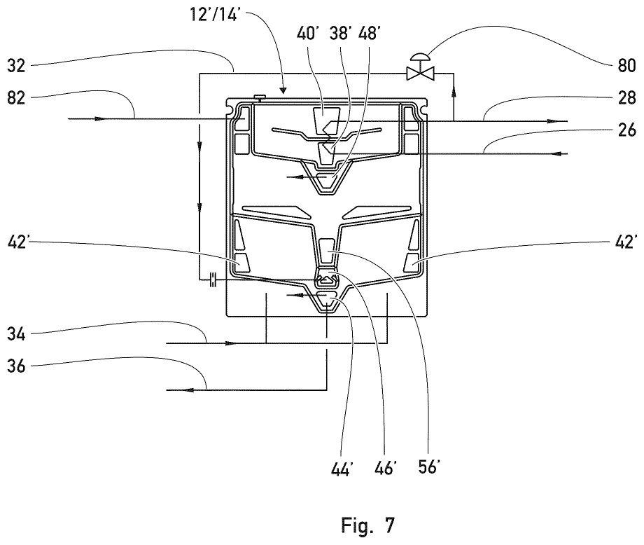

FIG. 7 shows a single steam-driven heat exchanger 12′ having a single plate package 14′. The plates 12′ in the plate package 14′ are similar to those disclosed in FIG. 4A and B. The steam is supplied to vaporized heating fluid inlet port 42′ via the heating fluid inlet conduit 34 and the condensed steam, i.e. water, is collected from the condensed heating flid outlet port 44′ via the heating fluid outlet 36. The steam may be provided from a steam turbine. Steam can optionally also be supplied to the condensation section via the conduit 82.

The liquid feed, such as sea water, is introduced at the untreated feed inlet port 46′. The liquid feed is evaporated in the evaporation section of the plate package 14′ as explained in connection with FIG. 4.

The cooling fluid, e.g. sea water, is introduced to the cooling fluid inlet port 38′ via the cooling fluid inlet conduit 26 and returned from the cooling fluid outlet port 40′ via the cooling fluid outlet conduit 28. However, some of the cooling fluid which has been heated as a result of the heat transfer with the evaporated feed is led to the untreated feed inlet port 46′ as liquid feed via the sea water inlet conduit 32. The amount of heated cooling fluid led to the untreated feed inlet port 46′ is controlled by a valve 80. The non-evaporated feed, i.e. brine, is led out via the non-evaporated feed outlet port 56′

The cooling fluid is used for condensing the evaporated feed as described in connection with FIG. 4. The condensed feed, such as freshwater, is led out via the treated feed outlet port 48′ and the condensed heating fluid is led out via the condensed heating fluid outlet port 44′ to the condensed heating fluid outlet conduit 36. The condensed heating fluid can be freshwater.

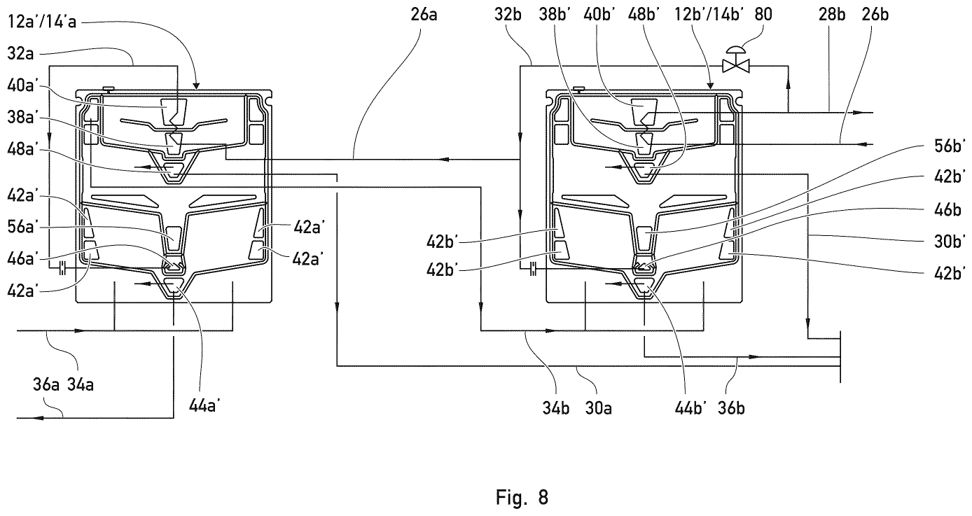

FIG. 8 shows a double steam-driven heat exchanger setup having a first plate package 14a′ and a second plate package 14b′ connected in series. The plate packages 14a′ 14b′ are identical having substantially identical plates 12a′ 12b′, respectively. The plates 12′a 12′b are similar to those disclosed in FIG. 4A and B.

The cooling fluid is introduced at the cooling fluid inlet conduit 26b of the second plate package 14b′ and some of the cooling fluid can be returned at the cooling fluid outlet conduit 28b. However, some of the cooling fluid which has been heated as a result of the heat transfer with the evaporated feed is led via the conduit 32b to the untreated feed inlet port 46b′, similar to the embodiment of FIG. 7. This is controlled by the valve 80. Further, the first and second plate packages 14a′ 14b′ are interconnected via cooling fluid conduit 26a such that some of the cooling fluid from the conduit 32b which has been heated as a result of the heat transfer with the evaporated feed in the second plate package 14b′ is led to the cooling fluid inlet port 38a′ of the first plate package 14a′ for the cooling of the first plate package 14a′. The cooling fluid flowing from the cooling fluid outlet port 40a′ of the first plate package 14a′ is led to the untreated feed inlet port 46a′ of the first plate package 14a′ via the conduit 32a.

Vaporized heating fluid is introduced via the heating fluid inlet conduit 34a only into the vaporized heating fluid inlet 42a′ of the first plate package 12a′. The vaporized heating fluid inlet 42b′ of the second plate package 12b receives evaporated feed from the separation section of the first plate package 12a′ which is led via the heating fluid inlet conduit 34b. A part of the vaporized feed from the first plate package 14′a is thus used as vaporized heating fluid in the second plate package 14′b.

Similar to the embodiment of FIG. 4, the non-evaporated feed, i.e. brine, is led out via the brine outlet 56a′ 56b′. The condensate, such as freshwater, is led out via the treated feed outlet ports 48a′ 48b′ 44b′ to the fresh water conduits 30a 30b 36b, respectively. The condensed heating fluid from the heating fluid outlet 44a′ can be let out via the heating fluid outlet conduit 36a. It can in some cases also be treated as fresh water if the vaporized heating fluid is water.

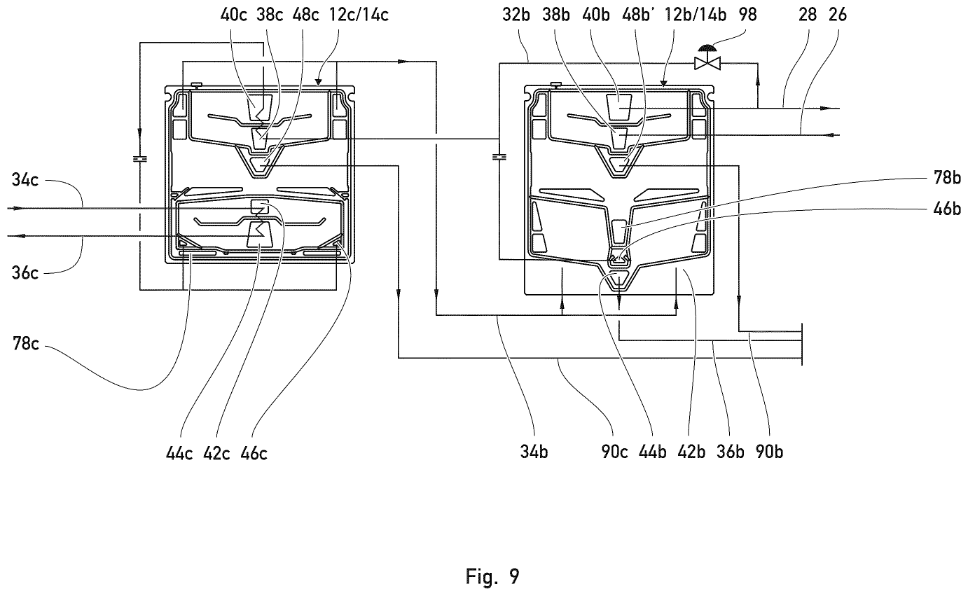

FIG. 9 shows a hot water driven heat exchanger setup having two plate packages 14b′ 14c connected in series similar to FIG. 8, whereby the second plate package 14b′ is substantially identical to the second plate package 14b of the embodiment of FIG. 4 whereas the third plate package 14c′ is replacing the first plate package 14a′ of the embodiment of FIG. 8. The third plate package 14c is a standard hot water driven single stage plate package having plates 12c′ as described in WO 2019/234015 A1 and in connection with FIG. 3.

In the third plate package 14c, a liquid heating fluid such as jacket water is introduced at the inlet 34c and let out at the outlet 36c. The liquid heating fluid is used for evaporating the feed in the evaporation section of the first plate package 14c as known in the prior art. Thus, the heating fluid is liquid and no condensation is taking place of the heating fluid in the present embodiment.

Similar to the embodiment of FIG. 8, evaporated feed is taken from the separation section of the third plate package 14c and led into the vaporized heating fluid inlet of the heating section of the second plate package 14b via the conduit 34b. Otherwise, the embodiment of FIG. 9 is identical to the embodiment of FIG. 8.

1. A method of treatment of a liquid feed such as sea water, the method comprising:
providing a plate heat exchanger including a plate package comprising a plurality of heat exchanging plates, each heat exchanging plate comprising a first surface and an opposite second surface, the heat exchanging plates being arranged in a successive order with a gasket in-between and the heat exchanging plates are oriented such that first surfaces of adjacent plates are facing each other, and second surfaces of adjacent plates are facing each other, each heat exchanging plate further comprising:
a heating section being located on the first surface,
a heating fluid inlet port and a heating fluid outlet port in the heating section,
an evaporation section being located on the second surface at least partially overlapping the heating section at an overlapping portion, the plate defining a thermal interface between the heating section and the evaporation section at the overlapping portion,
a feed inlet port in the evaporation section,
a separation section,
a condensation section,
a feed outlet port in the condensation section,
the method further comprising:
a vaporized heating fluid into the heating section via the heating fluid inlet port,
introducing a liquid feed into the evaporation section via the feed inlet port,
evaporating at least a part of the liquid feed in the evaporation section while condensing the vaporized heating fluid into a condensed heating fluid in the heating section,
receiving the feed from the evaporation section into the separation section,
separating the feed into a non-evaporated part of the feed and an evaporated part of the feed in the separation section,
receiving the evaporated part of the feed from the separation section into the condensation section,
condensing the evaporated part of the feed into a condensed feed in the condensation section,
discharging the condensed heating fluid from the heating section via the heating fluid outlet port, and
discharging the condensed feed from the condensation section via the feed outlet port.

2. The method according to claim 1, wherein the evaporation section and condensation section comprises obliquely extending ridges and valleys and the separation section comprises transversally extending ridges and valleys.

3. The method according to claim 1, wherein the plate comprising a non-evaporated feed outlet port in the separation section further comprising and the method comprising discharging the non-evaporated part of the feed via the non-evaporated feed outlet port.

4. The method according to claim 1, wherein the separation section is located between the evaporation section and the condensation section.

5. The method according to claim 1, wherein the evaporation section is located in the lower part of the plate when the heat exchanger is in use and the condensation section is located in the upper part of the plate when the heat exchanger is in use.

6. The method according to claim 1, wherein the gasket is sloped towards the heating fluid outlet port.

7. The method according to claim 1, wherein the condensation section is located on one of the first and second surfaces and the plate comprises a cooling section located on the opposite surface relative to the condensation section, the plate comprising a cooling fluid inlet port and a cooling fluid outlet port in the cooling section, the method further comprising circulating a cooling fluid in the cooling section via the cooling fluid inlet port and the cooling fluid outlet port.

8. The method according to claim 1, wherein each plate further comprising:
a secondary evaporation section on the opposite surface of the plate relative to the condensation section, the secondary evaporation section at least partly overlapping the condensation section at a secondary overlapping portion on the opposite surface of the plate relative to the condensation section, the plate defining a thermal interface between the condensation section and the secondary evaporation section at the secondary overlapping portion,
a secondary feed inlet port in the secondary evaporation section,
a secondary separation section,
a secondary condensation section, and
a secondary feed outlet port in the secondary condensation section,
the method further comprising:
introducing the secondary feed via the secondary feed inlet,
evaporating at least a part of a secondary feed in the secondary evaporation section,
receiving the secondary feed from the secondary evaporation section into the secondary separation section,
separating the secondary feed into a non-evaporated part of the secondary feed and an evaporated part of the secondary feed,
receiving the evaporated part of the secondary feed from the secondary separation section into the secondary condensation section,
condensing the evaporated part of the secondary feed into a condensed secondary feed in the secondary condensation section, and
discharging the condensed secondary feed at the secondary feed outlet.

9. The method according to claim 8, wherein the secondary condensation section is located on one of the first and second surfaces and the plate comprises a cooling section located on the opposite surface relative to the secondary condensation section, the plate comprising a cooling fluid inlet port and a cooling fluid outlet port in the cooling section, the method further comprising circulating a cooling fluid in the cooling section via the cooling fluid inlet port and the cooling fluid outlet port.

10. The method according to claim 1, wherein the method comprising:
providing a further heat exchanger including a further plate package comprising a plurality of further heat exchanging plates, each further heat exchanging plate comprising a further first surface and an opposite further second surface, each further heat exchanging plate further comprising:
a tertiary evaporation section,
a tertiary feed inlet port in the tertiary evaporation section,
a tertiary separation section,
a tertiary condensation section,
a tertiary feed outlet port in the tertiary condensation section,
the method further comprising:
introducing the tertiary liquid feed into the tertiary evaporation section via the tertiary feed inlet port,
evaporating at least a part of the tertiary liquid feed in the tertiary evaporation section,
receiving the tertiary feed from the evaporation section into the separation section,
separating the tertiary feed into a non-evaporated part of the tertiary feed and an evaporated part of the tertiary feed,
receiving a first part of the evaporated part of the tertiary feed from the tertiary separation section into the tertiary condensation section,
condensing the first part of the evaporated part of the tertiary feed into a condensed tertiary feed in the tertiary condensation section,
discharging the condensed tertiary feed from the tertiary condensation section via the tertiary feed outlet port, and
flowing a second part of the evaporated part of the tertiary feed into the heating fluid inlet port as vaporized heating fluid.

11. The method according to claim 10, wherein the further heat exchanging plate comprising:
a further heating section being located on the further first surface while the tertiary evaporation section being located on the further second surface, the further heating section at least partially overlapping the tertiary evaporation section at an overlapping portion, the further plate defining a thermal interface between the further heating section and the tertiary evaporation section at the overlapping portion
a tertiary heating fluid inlet port and a tertiary heating fluid outlet port at the further heating section,
the method further comprising:
introducing a further vaporized heating fluid into the further heating section via the tertiary heating fluid inlet port,
condensing the further vaporized heating fluid in the further heating section into a condensed heating fluid, and
discharging the condensed heating fluid from the further heating section via the tertiary heating fluid outlet port.

12. The method according to claim 10, wherein the further heat exchanging plate comprising:
a further heating section being located on the further first surface while the tertiary evaporation section being located on the further second surface, the further heating section at least partially overlapping the tertiary evaporation section at an overlapping portion, the further plate defining a thermal interface between the further heating section and the tertiary evaporation section at the overlapping portion,
a tertiary heating fluid inlet port and a tertiary heating fluid outlet port at the further heating section,
the method further comprising:
introducing a liquid heating fluid into the further heating section via the tertiary heating fluid inlet port, and
discharging the liquid heating fluid from the further heating section via the tertiary heating fluid outlet port.

13. The method according to claim 1, wherein the heating fluid outlet port is located below the evaporation section when the heat exchanger is in use.

14. A plate for a plate heat exchanger for treatment of a feed such as sea water, the plate heat exchanger including a plate package comprising a plurality of heat exchanging plates, the heat exchanging plate comprising a first surface and an opposite second surface, the heat exchanging plate further comprising:
a heating section being located on the first surface,
a heating fluid inlet port in the heating section for introducing a vaporized heating fluid into the heating section and a heating fluid outlet port in the heating section for discharging a condensed heating fluid in the heating section,
an evaporation section being located on the second surface at least partially overlapping the heating section at an overlapping portion, the plate defining a thermal interface between the heating section and the evaporation section at the overlapping portion for evaporating at least a part of a liquid feed in the evaporation section while condensing the vaporized heating fluid into the condensed heating fluid in the heating section,
a feed inlet port in the evaporation section for introducing the liquid feed into the evaporation section,
a separation section for separating the feed into a non-evaporated part of the feed and an evaporated part of the feed in the separation section,
a condensation section for condensing the evaporated part of the feed into a condensed feed,
a feed outlet port in the condensation section for discharging the condensed feed from the condensation section.

15. A plate heat exchanger for treatment of a feed such as sea water, the plate heat exchanger including a plate package comprising a plurality of heat exchanging plates according to claim 14, the plates being arranged in a successive order with a gasket in-between and the plates are oriented such that first surfaces of adjacent plates are facing each other and second surfaces of adjacent plates are facing each other.

16. A gasket for a plate heat exchanger according to claim 15, the gasket comprising an upper gasket member, a lower gasket member opposite the upper gasket member and two parallel side gasket members interconnecting the lower gasket member and the upper gasket member.

17. The method according to claim 1, wherein the gasket is sloped towards the heating fluid outlet port, and the heating fluid outlet port is centrally located on the plate.

18. The method according to claim 1, wherein the gasket is sloped towards the heating fluid outlet port, and each heat exchanging plate includes two heating fluid inlet ports each located at a respective side edge of the heat exchanging plate.

19. The method according to claim 1, wherein the condensation section is located on one of the first and second surfaces and the plate comprises a cooling section located on the opposite surface relative to the condensation section, the plate comprising a cooling fluid inlet port and a cooling fluid outlet port in the cooling section, the method further comprising circulating sea water as a cooling fluid in the cooling section via the cooling fluid inlet port and the cooling fluid outlet port, with heated cooling fluid being used as the feed.

20. The method according to claim 8, wherein the secondary condensation section is located on one of the first and second surfaces and the plate comprises a cooling section located on the opposite surface relative to the secondary condensation section, the plate comprising a cooling fluid inlet port and a cooling fluid outlet port in the cooling section, the method further comprising circulating sea water as a cooling fluid in the cooling section via the cooling fluid inlet port and the cooling fluid outlet port, with heated cooling fluid being used as the feed.
